(19) United States
(12) Patent Application Publication
(10) Pub. No.: US 2002/0197001 A1
(43) Pub. Date: Dec. 26, 2002

(54) Optical crossconnect system and its controller and method

(76) Inventors: Michiaki Hayashi, Kamifukuoka-shi (JP); Tomohiro Otani, Kamifukuoka-shi (JP); Hideaki Tanaka, Kamifukuoka-shi (JP); Masatoshi Suzuki, Kamifukuoka-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/176,000

(22) Filed: Jun. 19, 2002

(30) Foreign Application Priority Data
Jun. 25, 2001 (JP) 2001-191499

(51) Int. Cl. G02B 6/35; G02B 6/26

(52) U.S. Cl. 385/17; 385/15

(57) ABSTRACT

An optical crossconnect system comprises an input stage including a plurality of input matrix switches, each having a plurality of input ports and a plurality of output ports, an output stage including a plurality of output matrix switches, each having a plurality of input ports and a plurality of output ports, and an intermediate stage including a plurality of intermediate matrix switches, each having a plurality of input ports and a plurality of output ports. Each input port of each intermediate matrix switch connects to an output port which corresponds to the intermediate matrix switch, at an input matrix switch corresponding to the input port in the plurality of input matrix switches. Each output port of each intermediate matrix switch connects to an input port, which corresponds to the intermediate matrix switch, at an output matrix switch corresponding to the output port in the plurality of output matrix switches. At least one output port nearest to the input side in each of the plurality of input matrix switches is reserved for protection and at least one input port nearest to the output side in each of the plurality of output matrix switches is reserved for protection.

### CROSS REFERENCE TO RELATED APPLICATIONS

This application is based upon and claims the benefit of priority from the prior Japanese Patent Application No. 2001-191499, filed Jun. 29, 2001, the entire contents of which are incorporated herein by reference.

### FIELD OF THE INVENTION

This invention relates to an optical crossconnect system and its controller and method, more specifically relates to an optical crossconnect apparatus of multi-stage system matrix switches and its controlling device and method.

### BACKGROUND OF THE INVENTION

It is reported that as the Internet is generalized, the traffic of data transmission capacity has increased at a pace of twice a half-year. Together with the increase of demand for larger data transmission, bands required by users of communication systems have increased year by year. In recent years, such a system in which one wavelength is offered for only one user channel has remarkably increased in wavelength division multiplexing (WDM or DWDM) systems. In that service system, using a conventional configuration in which each terminal station disposed for every wavelength performs multiplexing/demultiplexing between high-speed and low-speed interfaces, adding/dropping, and crossconnecting at a low-speed interface increases costs, reduces operational efficiency, and increases terminal station installation spaces.

Under the circumstance, there is a great demand for an optical crossconnect apparatus that can efficiently perform circuit editing or network switching in an optical domain. For instance, an optical matrix switch in which a movable reflecting element for selecting either to reflect or to transmit is disposed on a crossover has attracted a considerable attention. One of the well-known configurations is that to use a mechanically movable reflecting mirror as the movable reflecting element (See, for example, L. Y. Lin, E. L. Goldstein and R. W. Tkach, “Free-space micromachined optical switches with submillisecond switching time for large scale optical crossconnects”, IEEE Photonics Technol. Lett., Vol. 10, No. 4, pp. 525-527) and another configuration is to utilize a babble generated in a grease drop through heating as the reflecting element (See, for example, J. E. Fouquet, “Compact optical crossconnect switch based on total internal refection in a fluid-containing planer lightwave circuit”, Optical Fiber Communication Conference (OFC) '00, TuM1-1, pp. 204-206).

Also, accompanying with an increasing number of channels, sizes of crossconnect apparatuses have become larger. However, it is not preferable to realize an electrically or optically large-sized crossconnect apparatus on a single matrix switching circuit. The reason is because reliability of a network to be offered is largely depend on reliability of an employed matrix switching circuit itself. Specifically, since a number of crosspoints in a matrix switch circuit increases by power as a number of input/output ports increases, a failure rate increases in proportion to the increase of the port number of the crossconnect apparatus and thus the reliability is reduced. When any failure occurs, the whole large-sized matrix switch has to be changed, and this means a stop of communication service of the whole channels including those having no fault.

To avoid such problem, in an electric crossconnect apparatus, a configuration in which small-sized matrix switches are connected in multi-stage has been proposed. Owing to the multi-stage connecting configuration, a total number of crosspoints (exchange points) of a matrix switch is reduced and reliability increases. Furthermore, there is a possibility to continuously use channels with no failure while a matrix switch with a failure is being replaced. That is, the maintenance becomes easier.

An electric crossconnect apparatus of multi-stage matrix switches and conditions for a complete nonblocking operation in which each input port connects to any one of output ports without fail in the apparatus are described in C. Clos, “A Study of Non-blocking Switching Networks”, The Bell System Technical Journal, pp. 406-424, March, 1953.

In accordance with contents of the above paper, an example in which a crossconnect apparatus is realized in, for instance, a three-stage configuration is described. The three-stage configuration comprises a plurality of first-stage matrix switches to divide a plurality of input ports into small-scale units, a plurality of third-stage matrix switches to divide a plurality of output ports into small-scale units, and a plurality of second-stage matrix switches located in the middle. In the first-stage, a number of matrix switches equivalent to a quotient obtained from dividing a number of input ports by an unitary port number is required, and a number of the output ports of each matrix switch is equal to a number of the second-stage matrix switches. In the third-stage, a number of matrix switches equivalent to a quotient obtained from dividing a number of output ports by an unitary port number is required, and a number of input ports of each matrix switch is equal to a number of the second-stage matrix switches. In the second-stage, a number of matrix switches equal to a number of ports of each matrix switch of the first-stage and third-stage is required, and also a number of input ports of each matrix switch needs to be equal to the number of matrix switches in the first-stage and a number of output ports of each matrix switch needs to be equal to the number of matrix switches in the third-stage. Generally, the number of matrix switches in the first-stage is equal to that of matrix switches in the third-stage.

For a complete nonblocking operation, the number of matrix switches in the second-stage is limited. Although the details are described in the above paper, on the assumption that the number of input ports of each matrix switch in the first-stage is “n” and the number of output ports of each matrix switch in the third-stage is “m”, the number of matrix switches in the second-stage is expressed as “n+m−1”.

For instance, in a case that a 16×16 crossconnect is to be realized with three-stage matrix switches, a configuration example in which 16 input ports and 16 output ports are divided into four matrix switches of four-port unit respectively is explained. In this case, four matrix switches are disposed in the first-stage, seven (=4+4−1) matrix switches are disposed in the second-stage, and four matrix switches are disposed in the third-stage. In the first-stage, a number of input ports of each matrix switch is four and a number of output ports is seven equal to that of matrix switches in the second-stage. In the third-stage, a number of output ports of each matrix switch is four, and a number of input ports is seven equal to that of matrix switches in the second matrix switches.

More generally, in a case that a crossconnect having N input ports and M output ports is to be realized with three-stage matrix switches, its configuration is shown below. That is, on the assumption that a number of input ports of each matrix switch in the first-stage is “n” and a number of output ports of each matrix switch in the third-stage is “m”, a required number of the matrix switches in the second-stage is expressed as (n+m−1). Therefore, n×(n+m−1) matrix switches are required by N/n in the first-stage, and (n+m−1)×m matrix switches are required by M/m in the third-stage.

In an optical network in which a large amount of data are transmitted fast, it is important not only reliability of trunk components but also easiness of maintenance. In a trunk network, it is especially important to suppress time for stopping of signal transmission while a component with a failure is being replaced.

An optical crossconnect apparatus is disposed at a trunk network area where a large capacity of traffic is centered. When a fault occurs inside such a crossconnect apparatus, it is desired to save main signals as much as possible and to save main signals related to the fault as fast as possible. For such purpose, a redundant configuration has been conventionally proposed, in which two optical crossconnect apparatuses are disposed in parallel making it possible, when one optical crossconnect apparatus has a fault, to switch main signals into the other optical crossconnect apparatus.

In such a conventional redundant configuration that provides two systems of optical crossconnect apparatuses, it is necessary to dispose an optical signal distributor between every mutually corresponding ports on input side of both working optical crossconnect apparatus and reserved optical crossconnect apparatus, and to dispose an optical signal selector between every mutually corresponding ports on output side. For instance, a 6×16 optical crossconnect needs to have 16 optical signal distributors and 16 optical signal selectors. This causes a dramatic increase in the apparatus size, and thus housing efficiency of traffic is decreased. Furthermore, a signal selector is required on each crosspoint of both working line and reserved line, and the reliability of the apparatus itself and consequently network remarkably decreases due to the reliability of the signal selector.

In addition, optical matrix switches comprise movable reflectors of a number equal to that of crosspoints which determine the reliability of the optical matrix switches. In other words, generally even when a single movable reflector has a failure, the optical matrix switch has to be replaced.

### SUMMARY OF THE INVENTION

An optical crossconnect system according to the invention comprises an input stage including a plurality of input matrix switches, each having a plurality of input ports and a plurality of output ports, an output stage including a plurality of output matrix switches, each having a plurality of input ports and a plurality of output ports, and an intermediate-stage including a plurality of intermediate matrix switches, each having a plurality of input ports and a plurality of output ports, wherein each input port of each intermediate matrix switch connects to an output port, which corresponds to the intermediate matrix switch, at an input matrix switch corresponding to the input port in the plurality of input matrix switches, each output port of each intermediate matrix switch connects to an input port, which corresponds to the intermediate matrix switch, at an output matrix switch corresponding to the output port in the plurality of output matrix switch, at least one output port nearest to an input side in each of the plurality of input matrix switches is reserved for protection and at least one input port nearest to the output side in each of the plurality of the output matrix switches is reserved for protection.

Due to this structure, a most reliable port is reserved for protection and therefore an emergency route is retained without fail whenever a failure occurs.

According to the invention, a controller of an optical crossconnect apparatus comprising an input stage having a plurality of input matrix switches, an output stage having a plurality of output matrix switches, and an intermediate stage having a plurality of intermediate matrix switches including at least one reserved intermediate matrix switch, comprises a fault table to store whether any fault exists and, if any, where a fault exists in the plurality of input matrix switches, the plurality of output matrix switches, and the plurality of intermediate matrix switches, an working route table to store working routes of the optical crossconnect apparatus, a fault location determining apparatus to determine a fault occurrence location, and a route controller to set a new route on a fault occurrence between an input port and an output port of the optical crossconnect apparatus whose route is blocked by the fault.

The route controller comprises first route controlling mode to refer to the fault table and working route table, when a fault occurs in at least one of the input and output stages, to make a list of intermediate matrix switches that can newly connect between an input port and an output port of the optical crossconnect apparatus whose route is blocked by the fault from the intermediated matrix switches except for the reserved intermediate matrix switches, to determine an intermediate matrix switch to be used from the list, and to construct a new route, second route controlling mode to refer to the fault table and working route table when a fault occurs only in the intermediate stage, to make a list of intermediate matrix switches that can newly connect between an input port and an output port of the optical crossconnect apparatus whose route is blocked by the fault from the intermediate matrix switches except for the intermediate matrix switch having the fault and reserved intermediate matrix switch, to determine an intermediate matrix switch to be used from the list, and to construct a new route, and a third route controlling mode to refer to the fault table and working route table when a fault occurs in both input stage and intermediate stage and a fault occurs in both output stage and intermediate stage, and to construct a new route between an input port and an output port of the optical crossconnect apparatus whose route is blocked by the fault using the reserved intermediate matrix switch in the intermediate matrix switches.

According to the invention, a controlling method of an optical crossconnect apparatus comprising an input stage having a plurality of input matrix switches, an output stage having a plurality of output matrix switches, and an intermediate stage having a plurality of intermediate matrix switches including at least one reserved intermediate matrix switch, comprises a fault storing step to store in a fault table whether any fault exists and, if any, where a fault locates in the plurality of input matrix switches, the plurality of output matrix switches, and the plurality of intermediate matrix switches, a working route storing step to store working routes of the optical crossconnect apparatus in a working route table, a fault location determining step to determine a fault occurrence location, a first route controlling step to refer to the fault table and working route table when a fault occurs in at least one of the input and output stages, to make a list of intermediate matrix switches that can newly connect between an input port and an output port of the optical crossconnect apparatus whose route is blocked by the fault from the intermediate matrix switches except for the reserved intermediate matrix switch, to determine an intermediate matrix switch to be used from the list, and to construct a new route, a second route controlling step to refer to the fault table and working route table when a fault occurs only in the intermediate stage, to make a list of intermediate matrix switches that can newly connect between an input port and an output port of the optical crossconnect apparatus whose route is blocked by the fault from the intermediate matrix switches except for the intermediate matrix switch having the fault and reserved intermediate matrix switch, to determine an intermediate matrix switch to be used from the list, and to construct a new route, and a third route controlling step to refer to the fault table and working route table when a fault occurs in both input and intermediate stages and a fault occurs in both output and intermediate stages, and to construct a new route between an input port and an output port of the optical crossconnect apparatus whose route is blocked by the fault using the reserved intermediate matrix switch in the intermediate matrix switches.

By employing the above configuration of controller and its method, a new appropriate route is configured step by step according to a fault occurrence location and conditions of working routes while a reserved intermediate matrix switch is reserved as long as possible.

### BRIEF DESCRIPTION OF THE DRAWING

The above and other objects, features and advantages of the current invention will be apparent from the following detailed description of the preferred embodiments of the invention in conjunction with the accompanying drawings, in which:

FIG. 1 shows a schematic block diagram of a first embodiment according to the invention;

FIG. 2 shows a route example before and after the first embodiment has a fault;

FIG. 3 shows a flow chart of path constructing routine of the first embodiment;

FIG. 4 shows a flow chart of path setting parameter calculating routine of the first embodiment;

FIG. 5 shows a flow chart of mode determining routine of the first embodiment;

FIG. 6 shows a flow chart of route list making routine of the first embodiment;

FIG. 7 shows a flow chart of fault processing routine of the first embodiment;

FIG. 8 shows a flow chart of relieving routine of the first embodiment; and

FIG. 9 shows a schematic block diagram of a second embodiment according to the invention.

### DETAILED DISCRIPTION

Embodiments of the invention are explained below in detail with reference to the drawings.

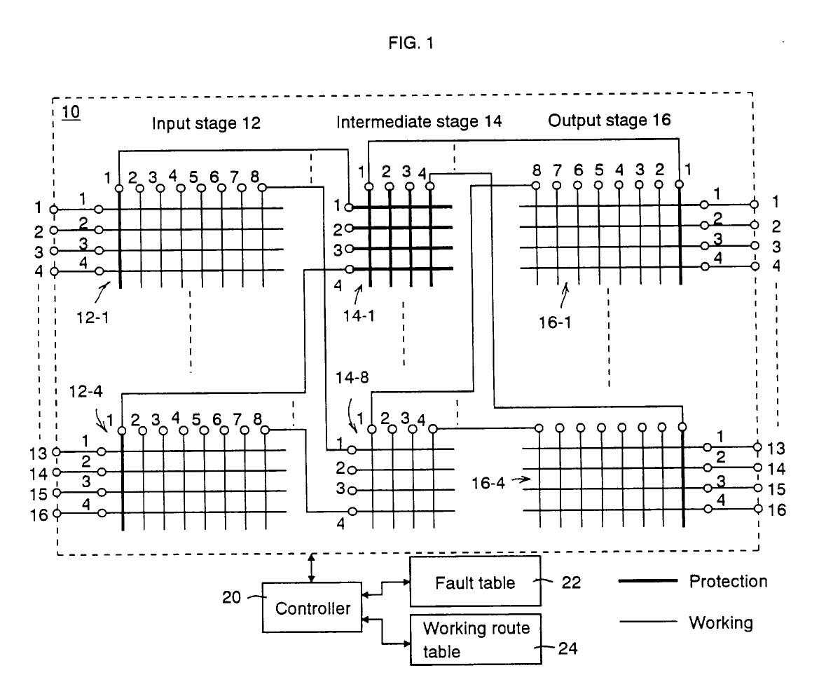

FIG. 1 shows a schematic block diagram of a first diagram according to the invention applied to a 16×16 optical crossconnect apparatus. It is assumed that a number of input ports of an optical crossconnect apparatus 10 in the embodiment is “N” (16 in the embodiment) and a number of output ports is “M” (16 in the embodiment). The optical crossconnect apparatus 10 comprises an input stage (a first stage) 12, an intermediate stage (a second stage) 14, and an output stage (a third stage) 16. Four matrix switches 12-1 through 12-4, each having four input ports, are disposed at the input stage 12, and four matrix switches 16-1 through 16-4, each having four output ports, are disposed at the output stage 16. Although the aforementioned paper describes that a number of matrix switches in the intermediate stage 14 required for realizing complete nonblocking operation is seven (=4+4−1), eight matrix switches 14-1 through 14-8 are disposed at the intermediate stage 14 to maintain redundancy in this embodiment.

An output port #j (j=1˜8) of a matrix switch 12-i (i=1˜4) of the input stage 12 connects to an input port #i of a matrix switch 14-j in the intermediate stage 14. An output port #j (j=1˜4) of a matrix switch 14-i (i=1˜8) in the intermediate stage 14 connects to an input port #i of a matrix switch 16-j in the output stage 16.

Since output ports of each of the matrix switches 12-1 through 12-4 in the input stage 12 connect to respective matrix switches 14-1 through 14-4 in the intermediate stage 14, each of matrix switches 12-1 through 12-4 in the input stage 12 comprises a matrix switch having four inputs and eight outputs. Similarly, since input ports of each of matrix switches 16-1 through 16-4 in the output stage 16 connect to respective matrix switches 14-1 through 14-8 in the intermediate stage 14, each of the matrix switches 16-1 through 16-4 comprises a matrix switch having eight inputs and four outputs.

A number of input ports of each of the matrix switches 14-1 through 14-8 in the intermediate stage 14 is equal to a number of matrix switches 12-1 through 12-4 in the input stage 12 and a number of output ports of each of the matrix switches 14-1 through 14-8 is equal to a number of matrix switches 16-1 through 16-4 in the output stage 16, and accordingly each of the matrix switches 14-1 through 14-8 in the intermediate stage 14 comprises a matrix switch having four inputs and four outputs.

The following are generalized descriptions of the above relations. That is, it is described on the assumption that the number of input ports of the optical crossconnect apparatus is “N”, the number of output ports is “M”, the number of input ports of each matrix switch in the input stage 12 is “n”, the number of output ports of each matrix switch in the output stage 16 is “m”, and the number of matrix switches in the intermediate stage 14 is “k”. Accordingly, the number of matrix switches in the input stage 12 is “N/n”, and the number of matrix switches in the output stage 16 is “M/m”. Each matrix switch in the input stage 12 comprises n×k matrix switches, each matrix switch in the intermediate stage 14 comprises (N/n)×(M/m) matrix switches, and each matrix switch in the output stage 16 comprises K×m matrix switches. The “k” can be any number as far as it is no less than (n+m).

By disposing the eight matrix switches 14-1 through 14-8 which number is larger than the indispensable number of (n+m−1) to realize a complete nonblocking operation, the redundancy according to the difference is secured. In this embodiment, for instance, the matrix switch 14-1 is protected as a reserved one and the matrix switches 14-2 through 14-8 are used in normal operation.

As previously explained, a main reason of a matrix switch failure is caused by a failure of a movable reflector. In a matrix switch, for example, that can select to transmit or reflect either a reflector is on its side or upright, its main failure is that the reflector does not stand up or lay down once it stands up. To avoid the latter failure, it is preferable to protect an output port nearest to the input port as a reserved route in the input stage 12 and to protect an input port nearest to the output port in the output stage 16. In the embodiment, as shown in FIG. 1, an output port #1 nearest to the input ports of each matrix switch 12-1 through 12-4 in the input stage 12 is connected to corresponding input ports #1 through #4 of matrix switches 14-1 in the intermediate stage 14, and an input port #1 nearest to the output ports of each matrix switch 16-1 through 16-4 in the output stage 16 is connected to corresponding output ports #1 through #4 of the matrix switches 14-1 in the intermediate stage 14.

In other words, in the embodiment, a route to transmit the matrix switch 14-1 has less reflecting elements on the crosspoints transmitting through in the input stage 12, intermediate stage 14 and output stage 16 compared to routes to transmit the other matrix switches 14-2 through 14-8. Accordingly, the reliability of the protected route becomes larger than that of the working routes and this is suitable for an emergency use.

A controller 20 stores the information of a failure location from the matrix switches 12-1 through 12-4, 14-1 though 14-8, and 16-1 through 16-4 in the optical crossconnect apparatus 10 in a failure table 22 and stores the information of working routes in the optical crossconnect apparatus 10 in a working route table 24. The failure table 22 and working route table 24 are sequentially updated. The controller 20 also controls the connection of each of the matrix switches 12-1 through 12-4, 14-1 through 14-8, and 16-1 through 16-4 according to connecting requests for crossconnect while referring to the failure table 22 and working route table 24.

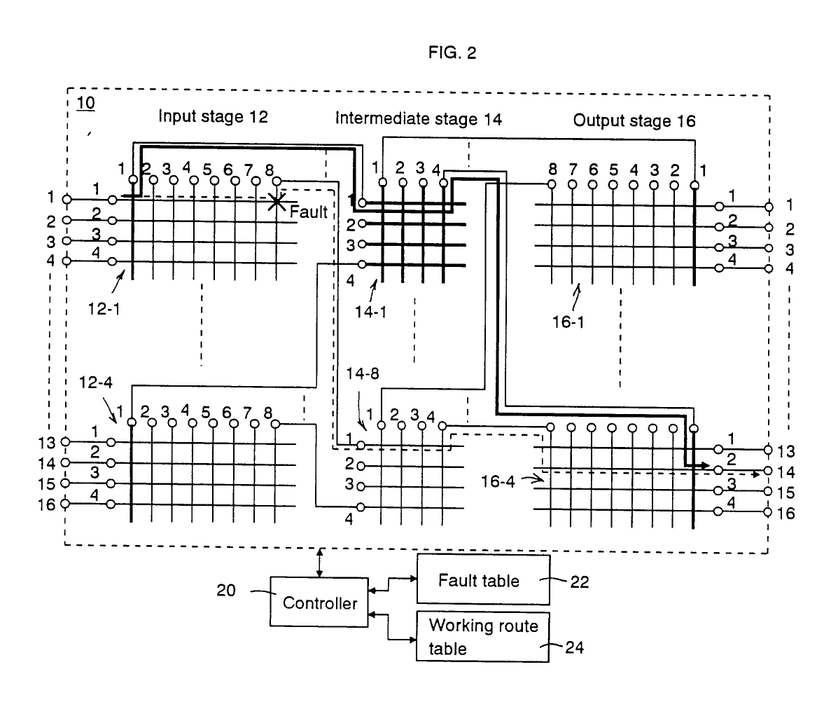

FIG. 2 shows a relief route in a case that a reflector located on a crosspoint of the input port #1 and the output port #8 of the matrix switch 10-1 has a failure when the input port #1 of the matrix switch 12-1 is connected to the output port #2 of the matrix switch 16-4. The solid line expresses a relief route and the broken line expresses a route before a failure occurs.

In the embodiment, to put it simple, optical signals whose number corresponds to the number of the matrix switch 12-1 through 12-4 in the input stage 12 can be protected at the maximum in a case that a failure occurs in the matrix switches 12-1 through 12-4 in the input stage 12. Similarly, optical signals whose number corresponds to the number of the matrix switches 16-1 through 16-4 in the output stage 16 can be protected at the maximum in a case that a failure occurs in the matrix switches 16-1 through 16-4 in the output stage 16.

When any of the matrix switches in the intermediate stage 14 has a failure, optical signals passing through the matrix switch having the failure are kept to bypass a reserved matrix switch while the matrix switch having the failure is being replaced, and thereafter the optical signals return to the former route. Similarly, in the input stage 12 and output stage 16, a fault part can be replaced with the minimum influence to other parts by separating substrate of the protected route part and the working route part of each matrix switch.

A penalty for signal transmission caused by the exchange of the fault part is merely the time required for changeovers of the matrix switches (changeovers are performed twice, namely from a matrix switch having a failure to a reserved matrix switch and then to a newly replaced matrix switch). Optical signals required to change their route are limited to those that pass through the fault matrix switch and therefore such influences caused by the failure and changeover of the fault matrix switch are insignificant.

There is little possibility that matrix switches have failures in more than one of the input stage 12, intermediate stage 14, and output stage 16 at the same time. Accordingly, even the redundancy is very low like this embodiment, the degree of the redundancy is practically satisfactory. When one of the matrix switches has a failure, it is replaced without giving influences to the transmission of many other signals and thus its maintenance becomes quite easy.

Next, the operation of the controller 20 is described. The operation of the controller 20 is realized by a plurality of programs. These programs are called whenever they are needed.

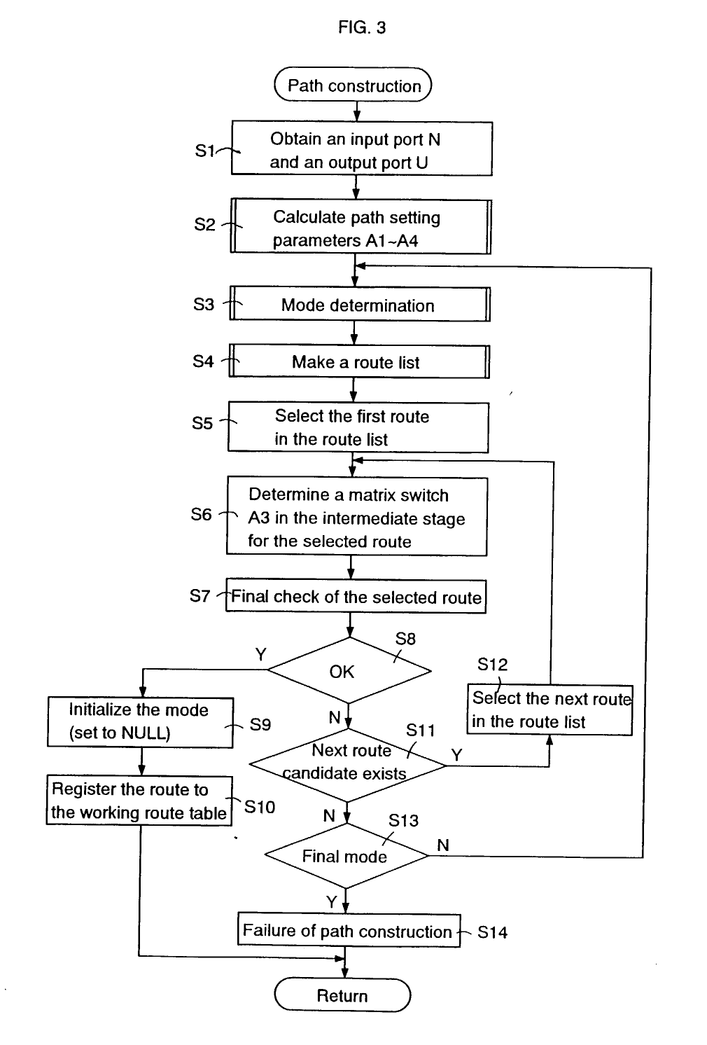

FIG. 3 shows a flow chart of path constructing routine when input port and output port of the optical crossconnect apparatus 10 are designated. An input port “N” and an output port “U” are obtained (S1), and from those numbers, a number of matrix switches in the input stage 12, and a number of matrix switches in the output stage 16, the number A1 of matrix switch in the input stage 12, the number A2 of input port in the matrix switch A1, the number A3 of matrix switch in the output stage 16, and the number A4 of output port in the matrix switch A3 are calculated (S2).

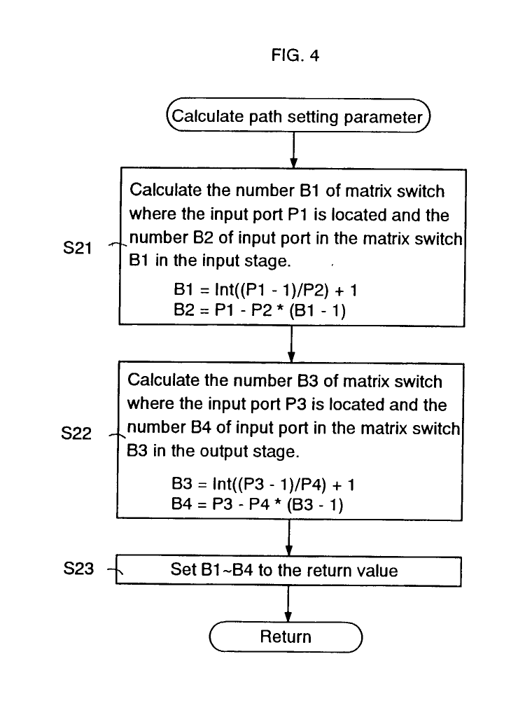

FIG. 4 shows a flow chart of a path setting parameter calculating routine (S2). Arguments of the path setting parameter calculating routine (S2) are “N”, the number of matrix switches in the input stage 12, “U”, and the number of matrix switches in the output stage 16, and they are assigned for internal variables P1, P2, P3, and P4 respectively. The return values are aforementioned A1, A2, A3, and A4.

In FIG. 4, in the input stage 12, the number B1 of matrix switch where the input port having the number N (=P1) is located and the number B2 of input port in the matrix switch B1 are calculated (S21). Arithmetically, they are expressed as follows:

B1=Int((P1−1)/P2)+1

B2=P1−P2×(B1−1)

Similarly, in the output stage 16, the number B3 of matrix switch where the input port having the number “U” (=P3) is located and the number B4 of input port in the matrix switch B3 are calculated (S22). Arithmetically, they are expressed as follows:

B3=Int((P3−1)/P4)+1

B4=P3−P4×(B3−1)

The obtained numbers B1, B2, B3, and B4 are set as return values, and then the operation returns to the flow shown in FIG. 3. When it returns to the step S2, the return values B1, B2, B3, and B4 in the routine shown in FIG. 4 are assigned to the variables A1, A2, A3, and A4.

In FIG. 3, an operation mode is determined using the A1, A3, and current mode as arguments (S3). Although the details are explained later, the operation mode includes a normal mode, a fault mode, and an NULL (so to speak, an undefined condition) which is neither of the above modes. Furthermore, there is a final mode that is set exceptionally when a path construction is ended in failure in both normal mode and fault mode.

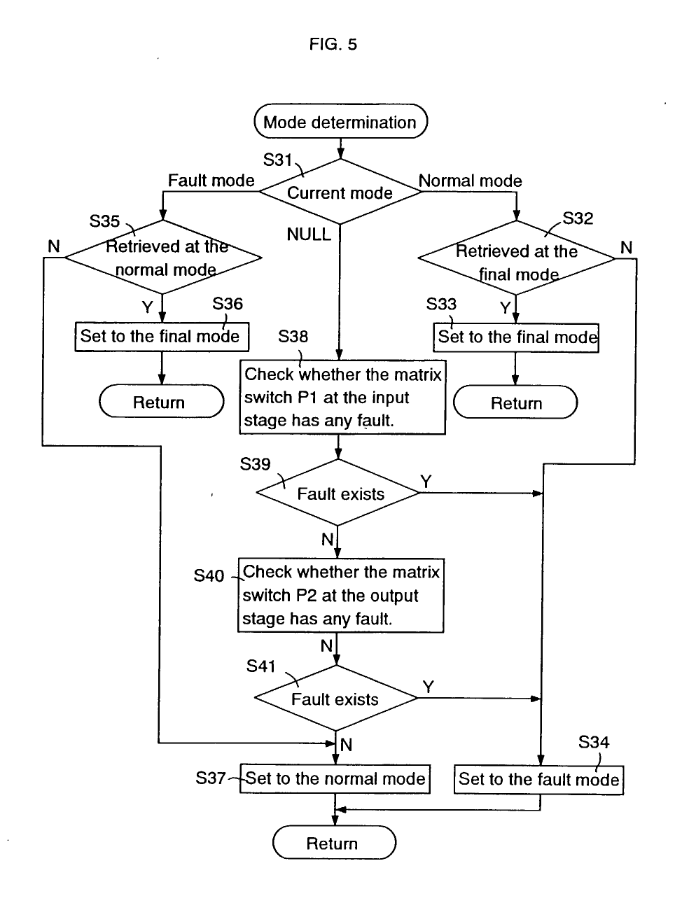

FIG. 5 shows a flow chart of the mode determining routine (S3). Arguments of the mode determining routine are the A1, A2, and current mode, and return value is determined mode. In the mode determining routine, A1 is assigned to P1 and A3 is assigned to P2.

The operation of FIG. 5 is explained next. When the current mode is the normal mode (S31), it is checked whether the connection between ports “N” and “U” designated at the step S1 is retrieved at the fault mode (S32). If it was already checked (S32), the mode is set to the final mode and it returns to FIG. 3 (S33), and if it was not yet checked (S32), the mode is set to the fault mode and returns to FIG. 3 (S34).

When the current mode is the fault mode (S31), it is checked whether the connection between ports “N” and “U” designated at the step S1 is retrieved at the normal mode (S35). If it was already checked (S35), the mode is set to the final mode and it returns to FIG. 3 (S36), if it was not yet checked (S35), the mode is set to the normal mode and it returns to FIG. 3 (S37).

When the current mode is under the undefined condition, namely the NULL (S31), it is checked whether the matrix switch P1 (=A1) at the input stage and matrix switch P2 (=A3) at the output stage have any fault according to the fault table 22 (S38, S40), if either one of the switches has a fault (S39, S41), the mode is set to the fault mode and it returns to FIG. 3 (S34), and if there is no fault (S39, S41) the mode is set to the normal mode and it returns to FIG. 3 (S37).

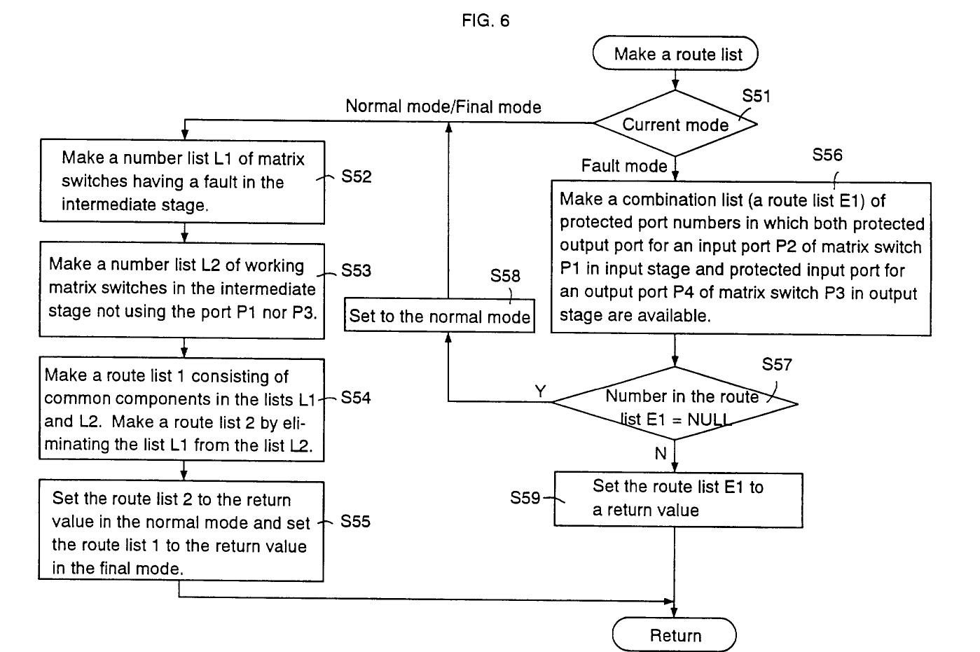

According to the mode set at the mode determining routine (S3), a list of routes which can connect between the ports “N” and “U” is created (S4). FIG. 6 shows a flow chart of the route list making routine (S4). Arguments of the route list making routine are A1, A2, A3, A4, and a current mode, and return value is the routine list. In the route list making routine, the values of the arguments A1, A2, A3, and A4 are assigned to the internal valuables P1, P2, P3, and P4 respectively.

In the route list making routine (S4), a current mode is checked first (S51). When the current mode is a normal mode or final mode (S51), a number list L1 of matrix switches having a fault in the intermediate stage according to the fault table 22 (S52). Also, a number list L2 of working matrix switches in the intermediate stage not using the input port P1 (=A1) nor the output port P3 (=A3) according to the working route table 24 (S53). The list L2 shows a single or a plurality of matrix switches available in the working matrix switches 14-2 through 14-8. The reason why the protected matrix switch 14-1 is not included in the list L2 is to try to select routes in the working matrix switches 14-2 through 14-8.

A route list 1 consists of common components in the lists L1 and L2. The remainder after eliminating the list L1 from the list L2 is a route list 2 (S54). When a current mode is the normal mode, the route list 2 is set as the return value and it returns to FIG. 3, and when the current mode is the final mode, the route list 1 is set as the return value and it returns to FIG. 3 (S55).

The route list 1 consists of a list of matrix switches having a failure and available for a new route setting in the intermediate stage 14. On the other hand, the route list 2 consists of a list of matrix switches having no failure and available for a new route setting in the intermediate stage 14.

To make the exchange of the broken matrix switches in the intermediate stage 14 easier, in the normal mode in which a route is created first, it is preferable to select a matrix switch to be used for a new route from the matrix switches having no failure in the intermediate stage 14. This is the reason to select the route list 2 in the normal mode. Since the final mode is a mode to be selected when neither the path construction in the normal mode nor the path construction using a protected route is impossible, a new path is constructed including the matrix switch having the failure in the intermediate stage 14 as a candidate. This is the reason to select the route list 1 in the final mode.

When a current mode is a fault mode (S51), an operating condition of a protected output port #1 for the input port P2 of the matrix switch P1 in the input stage 12 and an operating condition of the protected input port #1 for the output port P4 of the matrix switch P3 in the output stage 16 are checked according to the working route table 24, and a list (a route list) E1 composed of a combination of protected port numbers both available is prepared (S56). In the embodiment, a number of an output port of the matrix switch P1 of the input stage 12 and a number of an input port of the matrix switch P3 in the output stage 16 are both identical to a number of a matrix switch in the intermediate stage 14. Since it is advantageous for the operation to exchange a matrix switch having a failure in the input stage 12 or the output stage 16, in the step S56, a path candidate list on the protected route is prepared as a route list E1 regardless of the matrix switches in the intermediate stage 14. In the embodiment shown in FIG. 1, the matrix switch 14-1 in the intermediate stage is for protection and thus the route list El consists of the route information showing the matrix switch 14-1 in the intermediate stage 14.

When the route list E1 is empty (S57), a mode is set to the normal mode (S58) and the procedures after the step S52 are performed. When the route list E1 is not empty, the route list E1 is set to a return value and it returns to FIG. 3 (S59).

In FIG. 3, each candidate of the route list obtained by the route list making routine (S4) is arranged in order of the importance of path and checked according to this order whether it is possible to use without colliding with routes between other ports (the procedures after the step S5). The importance of the path, for example, depends on a level of line quality assurance for a user of the path.

To put it more concretely, the most important route is selected from the route list (S5), and a matrix switch A5 in the intermediate stage for the selected route is determined (S6). As A5 becomes smaller, a number of crosspoints on the route becomes fewer and thus the reliability of the route becomes higher. For instance, when A5 is equal to 1, a number of output port of the matrix switch in the input stage 12 becomes 1 and therefore input light branches into the intermediate stage at the first crosspoint. On the other hand, when A5 is equal to 8, a number of output port of matrix switch in the input stage 12 becomes 8 and thus input light of the matrix switch in the input stage 12 branches into the intermediate stage at the eighth crosspoint.

It is confirmed according to the fault table 22 and working route table 24 whether the route selected at the step S6 is practically available (S7). That is, it is checked whether a failure exists and whether any port is already used on a route determined by the input port A2 and output port A5 of the matrix switch A1 in the input stage 12, the input port A1 and output port A3 of the matrix switch A5 in the intermediate stage 14, and the input port A5 and output port A4 of the matrix switch A3 in the output stage 16 (S7). When a failure does not exist and no working port exists on the route (S8), the mode is initialized (set to NULL) (S9), the optical crossconnect apparatus 10 is controlled to set for the route, and the route is registered to the working route table 24 (S10).

If there is a fault on the route or any one of the ports is being used (S8), it is checked whether a next route candidate is available (S11). If the next route candidate exists (S11), the candidate is selected from the route list (S12) and the operation of S6 below is repeated. If a next route candidate does not exist (S11), and if the current mode is not the final mode (S13), the mode judgment (S3) below is repeated. If it is the final mode (S13), it is terminated warning the failure of path construction (S14).

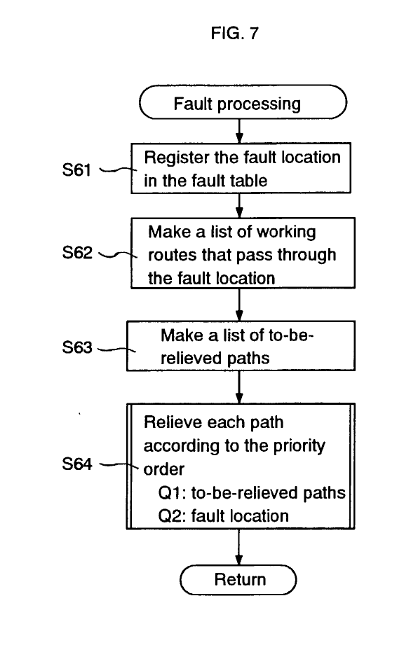

FIG. 7 shows a flow chart of processing routine of the controller 20 when it receives a report of fault occurrence from the optical crossconnect apparatus 10. The controller 20 registers the part having the fault on the fault table 22 (S61) when the fault occurrence is reported from the optical crossconnect apparatus 10. The fault is generally a fault of a reflector disposed on a crosspoint of matrix switches. The part having the fault can be specified, for example, from the information indicating a matrix switch having the fault and information indicating a crosspoint where the matrix switch is located.

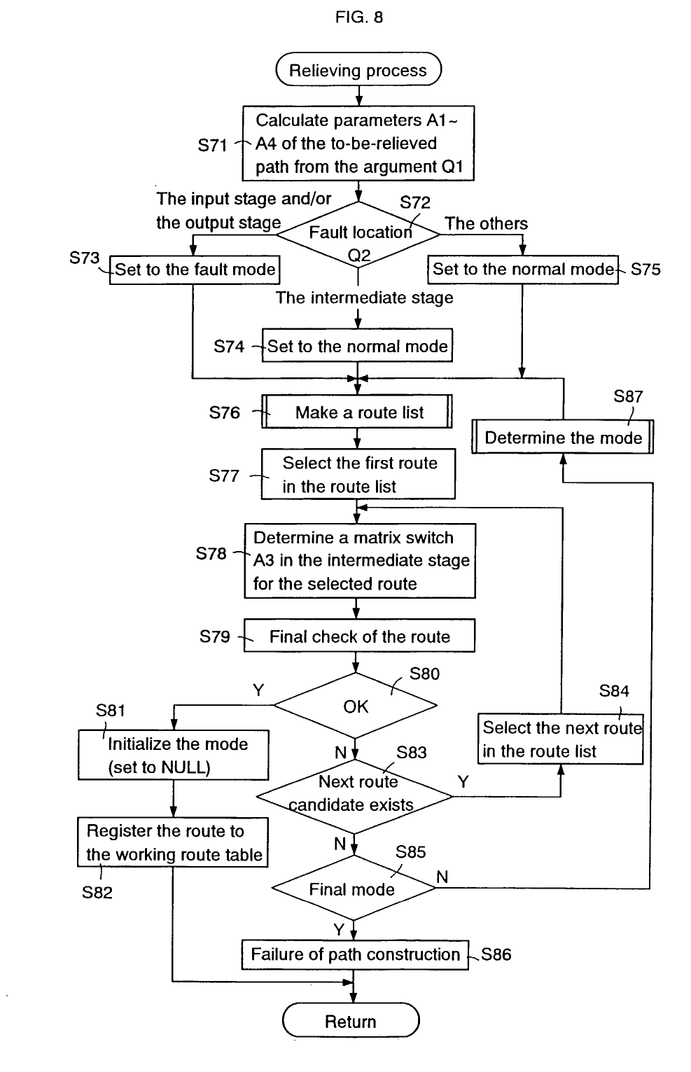

The controller 20 makes a list of working routes that pass through the fault part referring to the working route table 24 (S62), and makes a list of to-be-relieved paths from the list of working routes according to a certain priority order (S63). Then, the relieving process is performed for each path in the list of to-be-relieved paths according to the priority order (S64). FIG. 8 shows a flow chart of the relieving routine (S64). The to be-relieved paths and the fault part information are set as arguments of the relieving routine and then set to variables Q1 and Q2 locally.

The relieving process (S64) is explained in detail referring to FIG. 8. Parameters A1 through A4 of the to-be-relieved path are calculated from the argument Q1 (S71). A1 expresses a matrix switch in the input stage 12, and A2 expresses an input port in the matrix switch A1. A3 expresses a matrix switch in the output stage 16, and A4 expresses an output port in the matrix switch A3.

When a fault part that the argument Q2 indicates is in the input stage 12 and/or the output stage 16 (S72), the mode is set to a fault mode (S73). When the fault part is in the intermediate stage 14 (S72), the mode is set to a normal mode (S74). When neither of the above cases are applied, namely in such cases that a fault exists both in the input stage 12 and the intermediated stage 14, a fault exists both in the output stage 16 and intermediate stage 14, and a fault part is unknown (S72), the mode is set to a normal mode (S75).

Next, a route list is made, using the route list making routine shown in FIG. 6 according to the set mode (S76). Each candidate of the route list obtained from the route list making routine (S76) is arranged in order of importance of path and checked according to the order whether it is practically usable without colliding with routes between the other ports (S77 below). As previously explained, the importance of path is, for example, a level of line quality assurance for a user of the path.

To put it specifically, a route with the highest importance is selected from the route list (S77), and the matrix switch A5 in the intermediate stage 14 for the selected route is determined (S78). As already explained, as A5 becomes smaller, a number of the crosspoints on the route decreases and thus the reliability of the route improves.

Whether the route is practically usable is finally determined referring to the fault table 22 and the working route table 24 (S79). That is, it is checked whether any fault and any working port exists on the route determined by the input port A2 and output port A5 of the matrix switch A1 in the input stage 12, the input port A1 and output port A3 of the matrix switch A5 in the intermediate stage 14, and the input port A5 and output port A4 of the matrix switch A3 in the output stage 16 (S79). When no fault and working port exists (S80), the mode is initialized (set to NULL) (S81), the optical crossconnect apparatus 10 is controlled to set for the route, and the route is registered to the working route table 24 (S82).

When any fault exists or any port is being used (S80), it is checked whether a next candidate route exists (S83). When the next candidate route exists (S83), the next route is selected from the route list (S84) and the step S78 below is repeated. When any next candidate route does not exist (S83) and the current mode is not a final mode (S85), the mode is determined according to the mode determined routine shown in FIG. 5 (S87) and the step S76 below is repeated. When the current mode is a final mode (S85), it is terminated warning the failure of the path construction (S86).

To increase candidates for a reserved route, for example, a number of the output ports of each matrix switch in the input stage 12 and a number of input ports of each matrix switch in the output stage 16 are increased and then a number of the matrix switches in the intermediate stage 14 are increased accordingly. For instance, when the output ports #1 and #2 of each matrix switch in the input stage 12 and the input ports #1 and #2 of each matrix switch in the output stage 16 are assigned for protection, the matrix switches 14-1 and 14-2 in the intermediate stage 14 become reserved matrix switches.

This invention can expand to a configuration having odd-staged matrix switches. In such case, a first stage is considered as an input stage, a final stage is considered as an output stage, and the rest of the stages are considered as intermediate stages, and the processes shown in FIGS. 3 through 8 are applied to them to perform the path construction and the path reconstruction for relieving from faults. Sometimes, a recursive operation is required depending on processing contents of fault such as to detect whether any fault exists on a path. For example, in a case that a number of the stages is five, a first stage is considered as an input stage, a part composed of second, third, and fourth stages is considered as an intermediate stage, and a fifth-stage is considered as an output stage, and some of the processes shown in FIGS. 3 through 8 are performed, and furthermore the second stage is considered as an input stage, the third-stage is considered as an intermediate stage, and the fourth-stage is considered as an output stage, and some of the processes shown in FIGS. 3 through 8 are preformed.

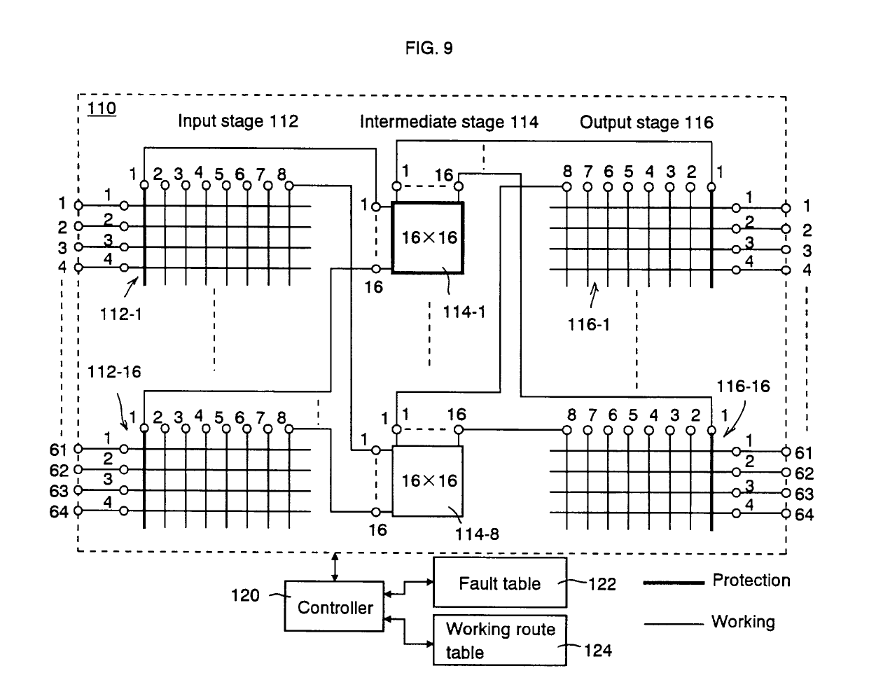

FIG. 9 shows a schematic diagram in which a second embodiment according to the invention is applied to a 64×64 optical crossconnect apparatus. A number of input ports of an optical crossconnect apparatus 110 is assumed “N” (64 in this embodiment) and a number of output ports is assumed “M” (64 in this embodiment). The optical crossconnect apparatus 110 comprises an input stage 112, an intermediate stage 114, and an output stage 116. Sixteen matrix switches 112 (112-1 through 112-16) each having four input ports and eight output ports are disposed in the input stage 112, eight matrix switches 114-1 through 114-8 each having sixteen input ports and sixteen output ports are disposed in the intermediate stage 114, and sixteen matrix switches 116 (116-1 through 11616) each having eight input ports and four output ports are disposed in the output stage 116. Although a number of the matrix switches in the intermediate stage required realizing the complete nonblocking operation is “7” (=4+4−1) as explained in the above paper, similarly to the embodiment shown in FIG. 1, eight matrix switches 114-1 through 114-8 are disposed in the intermediate stage 114 in the embodiment shown in FIG. 9 to maintain redundancy.

Each of the matrix switches 114-1 through 114-8 in the intermediate stage 114 can comprise either a 16×16 single matrix switch or a 16×16 matrix switch having the same configuration to that of the optical crossconnect apparatus 10 in FIG. 1. When the latter is employed, the embodiment shown in FIG. 9 is practically composed of five-stage matrix switches in which the first stage becomes the input stage 112, the fifth stage becomes the output stage 116, and the part of the second, third, and fourth stages becomes the intermediate stage 114.

In the embodiment shown in FIG. 9, similarly to the above embodiment, an output port #j (j=1˜8) of a matrix switch 112-i (i=1˜16) in the input stage 112 connects to an input port #i of a matrix switch 114-j in the intermediate stage 114. An output port #j (j=1˜16) of a matrix switch 114-i (i=1˜8) in the intermediate stage 114 connects to an input port #i of a matrix switch 16-j in the output stage 116.

In this embodiment, the number of the matrix switches 114-1 through 114-8 in the intermediate stage 114 is larger than 7 (=n+m−1) which is the number required realizing the complete nonblocking operation. In the description below, the matrix switch 114-1 is assigned to be a reserved matrix switch, and the matrix switches 114-2 through 114-8 are used in the normal operation. The routes that pass through the matrix switch 114-1 have a fewer number of reflector elements on the crosspoints to pass through in the input stage 112, the intermediate stage 114 and the output stage 116 compared to those of the routes that pass through the other matrix switches 114-2 through 114-8, and therefore the reliability becomes high.

A controller 120 operates basically in the same manner to the controller 20. That is, the controller 120 stores the information of fault locations from matrix switches 112-1 through 112-16, 114-1 through 114-8, and 116-1 through 116-16 in the optical crossconnect apparatus 110 in a fault table 122 and stores the information of working routes of the optical crossconnect apparatus 110 in a working route table 124. The fault table 122 and the working route table 124 are, similarly to the embodiment shown in FIG. 1, sequentially updated. The controller 120 also controls connection for each of matrix switches 112-1 through 112-16, 114-1 through 114-8, and 116-1 through 116-16 according to connecting request of the crossconnect while it refers to the fault table 122 and the working route table 124.

Some aspects that differ to the controller 20 are explained below. The path construction routine shown in FIG. 3 is changed as follows. After the matrix switch A3 in the intermediate stage 114 is determined in the step S6, a route inside the determined matrix switch A3 is determined according to the flow charts shown in FIGS. 3 through 8. In the next step S7, it is finally confirmed whether the route determined in the step S6 is practically usable. The rest of the operations are identical to those in the embodiment shown in FIG. 1.

The relieving routine shown in FIG. 8 is changed as explained below. In the step S72, when a fault part is in any one of the matrix switches 14-1 through 14-8 in the intermediate stage 114, the relieving routine shown in FIG. 8 is applied to perform a mode determining and path construction inside the matrix switch where the fault is detected. If a path can be constructed, goes forward to the step S76 keeping the mode set in the three-stage configuration, and if a path cannot be constructed, goes forward to the step S76 setting to a normal mode. The steps S78 and S79 are subject to be change similarly to the above explanation about the steps S6 and S7 shown in FIG. 3.

In each of the above embodiments, even if any one of the matrix switches constructing the optical crossconnect apparatuses 10 and 110 has a fault, a complete nonblocking operation can be continued using a reserved port.

Although, in the above example, a number of protected output ports of each matrix switch in the input stage and a number of protected input ports of each matrix switch in the output stage are both “1”, it is applicable that more protected output ports and protected input ports are set to each matrix switch in the input stage and each matrix switch in the output stage respectively. According to a number of the protected output ports and a number of protected input ports, the matrix switches in the intermediate stage are increased. The more the number of protected output ports and protected input ports increase, the more the redundancy increases and becomes durable for faults.

Generally, the number of protected output ports of each matrix switch in the input stage is not necessarily equal to that of protected input ports of each matrix switch in the output stage. Also, generally, the number of input ports of each matrix switch in the input stage is not necessarily equal to that of output ports of each matrix switch in the output stage.

Although a two-dimensional array type in which a route is selected by standing up a mirror on a crosspoint of an input port and an output port as an example of optical matrix switch, any type is applicable as far as it is capable of changing optical routes such a configuration that connects an input signal with a desired output port by changing an angle of a mirror. A port located in the most reliable point in view of operating characteristics of elements is selected as a protected port.

As readily understandable from the aforementioned explanation, according to the invention, the following effects are obtained. That is, the current invention can greatly reduce a number of components and thus reduce a physical size compared to a configuration that provides two kinds of systems in parallel. When a fault component exists, it is possible to replace the fault component with the minimal penalty and accordingly the maintenance becomes much easier. Since one or a plurality of routes with high reliability is saved as protected routes, it becomes easy to relieve the failure in working routes.

Also, according to the locations of fault occurrence and the conditions of working routes, new appropriate routes can be set step by step while keeping reserved intermediate matrix switches as much as possible.

While the invention has been described with reference to the specific embodiment, it will be apparent to those skilled in the art that various changes and modifications can be made to the specific embodiment without departing from the spirit and scope of the invention as defined in the claims.

1. An optical crossconnect system comprising:
an input stage including a plurality of input matrix switches, each having a plurality of input ports and a plurality of output ports;
an output stage including a plurality of output matrix switches, each having a plurality of input ports and a plurality of output ports; and
an intermediate stage including a plurality of intermediate matrix switches, each having a plurality of input ports and a plurality of output ports;
wherein each input port of each intermediate matrix switch connects to an output port which corresponds to the intermediate matrix switch, at an input matrix switch corresponding to the input port in the plurality of input matrix switches;
each output port of each intermediate matrix switch connects to an input port, which corresponds to the intermediate matrix switch, at an output matrix switch corresponding to the output port in the plurality of output matrix switches; and
at least one output port nearest to the input side in each of the plurality of input matrix switches is reserved for protection and at least one input port nearest to the output side in each of the plurality of output matrix switches is reserved for protection.

2. The crossconnect system of claim 1 further comprising:
a fault table to store whether any fault exists in the input matrix switch, the output matrix switch, and the intermediate matrix switch;
a working route table to store working routes; and
a controller to refer to the fault table and working route table according to a fault occurrence in any of the input matrix switch, the output matrix switch, and the intermediate matrix switch and to set a new route which bypasses the fault part.

3. A controller to control routes of an optical crossconnect apparatus comprising an input stage having a plurality of input matrix switches, an output stage having a plurality of output matrix switches, and a plurality of intermediate matrix switches including at least one reserved intermediate matrix switch, the controller comprising:
a fault table to store whether any fault exists and where a fault locates in the plurality of input matrix switches, the plurality of output matrix switches, and the plurality of intermediate matrix switches;
a working route table to store working routes of the optical crossconnect apparatus;
a fault location determining apparatuses to determine a fault occurrence location; and
a route controller to set a new route on a fault occurrence between an input port and an output port of the optical crossconnect apparatus whose route is blocked by the fault;
wherein the route controller comprising:
first route controlling mode to refer the fault table and the working route table when a fault occurs in at least one of the input and output stages, to make a list of intermediate matrix switches which can newly connect between an input port and an output port of the optical crossconnect apparatus whose route is blocked by the fault from the intermediate matrix switches except for the reserved intermediate matrix switch, to determine an intermediate matrix switch to be used from the list, and to construct a new route;
second route controlling mode to refer the fault table and the working route table when a fault occurs only in the intermediate stage, to make a list of intermediate matrix switches which can newly connect an input port and an output port of the optical crossconnect apparatus whose route is blocked by the fault from the intermediate matrix switches except for the intermediate matrix switch having the fault and the reserved intermediate matrix switch, to determine an inter mediate matrix switch to be used from the list, and to construct a new route;
third route controlling mode to refer the fault table and the working route table when a fault occurs in both input stage and the intermediate stage and a fault occurs in both output stage and intermediate stage, and to construct a new route between an input port and an output port of the optical crossconnect apparatus whose route is blocked by the fault using the reserved intermediate matrix switch in the intermediate matrix switches.

4. The controller of claim 3 wherein the route controller performs a route control using the first route controlling mode when no reserved intermediate matrix switch is available in the third route controlling mode.

5. The controller of claim 3 wherein the route controller performs construction of a new route in order of the first, third, and second route controlling modes.

6. The controller of claim 3 wherein each input port of each intermediate matrix switch connects to an output port, which corresponds to the intermediate matrix switch, at an input matrix switch corresponding to the input port in the plurality of input matrix switches;
each output port of each intermediate matrix switch connects to an input port, which corresponds to the intermediate matrix switch, at an output matrix switch corresponding to the output port in the plurality of output matrix switch; and
at least one output port nearest to an input side in each of the plurality of input matrix switch is reserved for protection and at least one input port nearest to an output side in each of the plurality of output matrix switches is reserved for protection.

7. A controlling method to control an optical crossconnect apparatus comprising an input stage having a plurality of input matrix switches, an output stage having a plurality of output matrix switches, and an intermediate stage having a plurality of intermediate matrix switches including at least one reserved intermediate matrix switches, the method comprising:
a fault storing step to store in a fault table whether and where a fault exists in the plurality of input matrix switches, the plurality of output matrix switches, and the plurality of intermediate matrix switches;
an working route storing step to store in a working route table about working route of the optical crossconnect apparatus;
a fault location determining step to determine a fault occurrence location;
a first route controlling step to refer the fault table and the working route table when any fault occurs in at least one of the input and output stages, to make a list of intermediate matrix switches which can newly connect between an input port and an output port of the optical crossconnect apparatus whose route is blocked by the fault, to determine an intermediate matrix switch to be used from the list, and to construct a new route;
a second route controlling step to refer to the fault table and the working route table when a fault occurs only in the intermediate stage, to make a list of intermediate matrix switches which can connect between an input port and an output port of the optical crossconnect apparatus whose route is blocked by the fault from the intermediate matrix switches except for the intermediate matrix switch having the fault and the reserved intermediate matrix switch, to determine an intermediate matrix switch to be used from the list, and to construct a new route; and
a third route controlling step to refer to the fault table and the working route table when a fault occurs in both input stage and intermediate stage and a fault occurs in both output stage and intermediate stage, and to construct a new route between an input port and an output port of the optical crossconnect apparatus whose route is blocked by the fault using the reserved intermediate matrix switch in the intermediate matrix switches.

8. The controlling method of an optical crossconnect apparatus of claim 7 further comprising a step to perform the first route controlling step when no reserved intermediate matrix switch is available in the third route controlling step.

9. The controlling method of an optical crossconnect apparatus of claim 7 to perform construction of a new route in order of the first, third, and second route controlling steps.

10. The controlling method of an optical crossconnect apparatus of claim 7 wherein:
each input port of each intermediate matrix switch connects to an output port, which corresponds to the intermediate matrix switch, at an input matrix switch corresponding to the input port in the plurality of input matrix switches;
each output port of each intermediate matrix switch connects to an input port, which corresponds to the intermediate matrix switch, at an output matrix switch corresponding to the output port in the plurality of output matrix switches; and
at least one output port nearest to an input side in each of the plurality of input matrix switches is reserved for protection and at least one input port nearest to an output side in each of the plurality of output matrix switches is reserved for protection.
